(19) United States
(12) Patent Application Publication
(10) Pub. No.: US 2002/0198807 A1
(43) Pub. Date: Dec. 26, 2002

(54) Product brokerage transaction processing system, and product brokerage transaction processing method and program

(75) Inventors: Susumu Kobayashi, Kawasaki (JP); Makoto Kitagawa, Fujisawa (JP); Toshiaki Tokunaga, Yokohama (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/179,575

(22) Filed: Jun. 24, 2002

(30) Foreign Application Priority Data
Jun. 26, 2001 (JP) 2001-192208

(51) Int. Cl. G06F 17/60

(52) U.S. Cl. 705/35

(57) ABSTRACT

A transaction processing system for a brokerage institution that mediates and processes transactions across product function supply systems at multiple financial institutions. The transaction processing system generates integrated products composed of work flows of transactions of financial products that compose the integrated products based on product information containing information indicating functional characteristics of the financial products offered by each financial institution, message specifications for performing transactions of the financial products, and rules regarding commissions for the transactions of these financial products, and offers the integrated products to end-users via a network. The transaction processing system manages a brokerage transaction process for an integrated product according to contents of parameters inputted by the end-user, directs the product function supply systems to execute transactions of the financial products composing the integrated product, and performs settlements of commissions for the transaction process of the integrated product according to transaction execution logs of the transactions.

### BACKGROUND OF THE INVENTION

1. Field of the Invention

The present invention relates to a product transaction process technology using computer networks, and more particularly, to a product brokerage transaction processing system, product brokerage transaction processing system method and program which would make transactions involving multiple financial institutions and financial products easier.

2. Description of Related Art

Conventionally, as a technology to perform transactions with multiple financial institutions, for example, a technology has been developed to execute various types of transactions using cards.

Also, there is a technology to perform brokerage transactions implemented as a financial information brokerage processing device and a recording medium that stores a financial information brokerage processing program.

These conventional technologies, however, basically deal with only single financial product (service). (In finance, when using terms such as “product” and “service,” it indicates that “product” is one of financial products that financial institutions offer and “service” is something that users can receive by using financial products from end-users′ point of view.

For instance, a main purpose of the bank deposit process of insurance premiums is an insurance premium payment process. As for the bank account which makes payments, the account itself does not have any purpose and only is used to keep associated funds. In other words, the financial product in this context is the insurance premium payment process alone.

When these financial products have more varieties, end-users could benefit from choosing products which meet their needs from various products that financial institutions offer, and from purposefully combining these various financial products and receiving a comprehensive financial service.

The conventional technology, however, does not allow transactions which combine each financial product of multiple financial institutions that users choose.

Furthermore, financial institutions generally tie-up their operations with other financial institutions to provide a combination of products offered separately by these financial institutions. Also, they develop a system whereby they execute transactions for the combined products in the computer system. These operational tie-ups and system developments take time and cost.

Accordingly, even if a financial institution designs a combined product which has a new concept, it will face difficulties to provide end-users with the service promptly and on a timely basis. Also, end-users can not necessarily use a combination of products that they choose.

Furthermore, when brokerage institutions act as a go-between for the products of financial institutions, these financial institutions pay the brokerage institutions commissions for such a service. It is, however, difficult for multiple financial institutions and brokerage institutions to set up these commissions independently and to structure independent systems to settle the commissions.

As noted above, the conventional technology could not cooperate the systems of multiple financial institutions in a flexible fashion. Even if financial institutions develop various financial services for users (customers), users (customers) will have to separately set up their choice of financial services and the transaction contents if they want to combine and use financial products according to their needs.

The conventional technologies can not cooperate multiple product supply systems, i.e., the systems of financial institutions, in a flexible fashion.

### SUMMARY OF THE INVENTION

The present invention resolves these issues presented by the conventional technologies, and provides a product brokerage transaction processing system, and a product brokerage transaction processing method and program which would make it easier for users to utilize product transactions involving multiple financial institutions, i.e., the systems of financial institutions.

In accordance with an embodiment of the present invention, in a product brokerage transaction processing system and a product brokerage transaction processing method, there is provided, for example, a transaction processing system for a brokerage institution that mediates and processes transactions across multiple financial institutions. The transaction processing system registers product information containing the information indicating functional characteristics of financial products offered by each financial institution, message specifications for performing transactions of the financial products, and rules regarding commissions for the transactions of these financial products. In addition, in the transaction processing system for the brokerage institution, definitions of flows of transaction of integrated products that combine various products may be registered. For example, definitions of work flows each consisting of transaction steps (wherein each of the steps defines a transaction of a product offered by each financial institution) may be registered. When the user selects and inputs parameters of a transaction flow for an integrated product from items of the product information, a transaction process will be carried out according to the definitions of the transaction flow and the selected parameters.

Furthermore, in the system and method in accordance with the present embodiment, a transaction log indicating each transaction history for each of the products is obtained when executing a transaction for each of the products, a settlement detail is formed according to the transaction log, and a settlement is made between each of the financial institutions and the brokerage institution. By doing so, transaction systems for financial products involving multiple financial institutions can be readily developed, because transactions for new integrated products can be supported through registering product information, performing registrations and changes of transaction flows of integrated products, and adding information such parameters.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a block diagram showing an example for the structure of a product brokerage transaction processing system in accordance with an embodiment of the present invention.

FIG. 2 is a flow chart showing the process operations relating to a product brokerage transaction processing method in accordance with an embodiment of the present invention in the product brokerage transaction processing system in FIG. 1.

FIG. 3 is a flow chart showing an example of the process operations at a product management section in the transaction processing system in FIG. 1.

FIG. 4 shows an example illustrating a structure of product information prepared and maintained by the process indicated in FIG. 3.

FIG. 5 is a flow chart showing an example of the preparation processing operations for integrated products by the transaction processing system in FIG. 1.

FIG. 6 shows an embodiment example of the integrated product preparation processing operations in FIG. 5.

FIG. 7 shows an exemplary structure of integrated products prepared in the integrated product preparation processing operations in FIG. 5.

FIG. 8 shows an exemplary structure of a display screen image for the contract of integrated products displayed on terminals used by end-users in FIG. 1.

FIG. 9 is a flow chart indicating an example of the processing operations at a contract information management section in the transaction processing system in FIG. 1.

FIG. 10 shows an exemplary structure of contract information prepared in the process in FIG. 9.

FIG. 11 is a flow chart indicating an example of the transaction execution processing operations for integrated products by the transaction processing system in FIG. 1.

FIG. 12 is a drawing for explaining details of a log record stored in the transaction log in FIG. 1.

FIG. 13 is a flow chart showing an example of the processing operations to extract detail information regarding commission settlements by a commission settlement management section in FIG. 1.

FIG. 14 is a flow chart showing the processing order in which commission settlements are performed in the transaction system in FIG. 1.

FIG. 15 is a drawing explaining a structure of a commission settlement billing message prepared in the process in FIG. 14.

FIG. 16 is a drawing explaining an example of the product transaction operations in the product brokerage transaction processing system in FIG. 1.

FIG. 17 is a block diagram showing a hardware structure of the product brokerage transaction processing system in FIG. 1.

### DESCRIPTION OF PREFERRED EMBODIMENTS

Preferred embodiments of the present invention will be described in detail below with reference to the accompanying drawings.

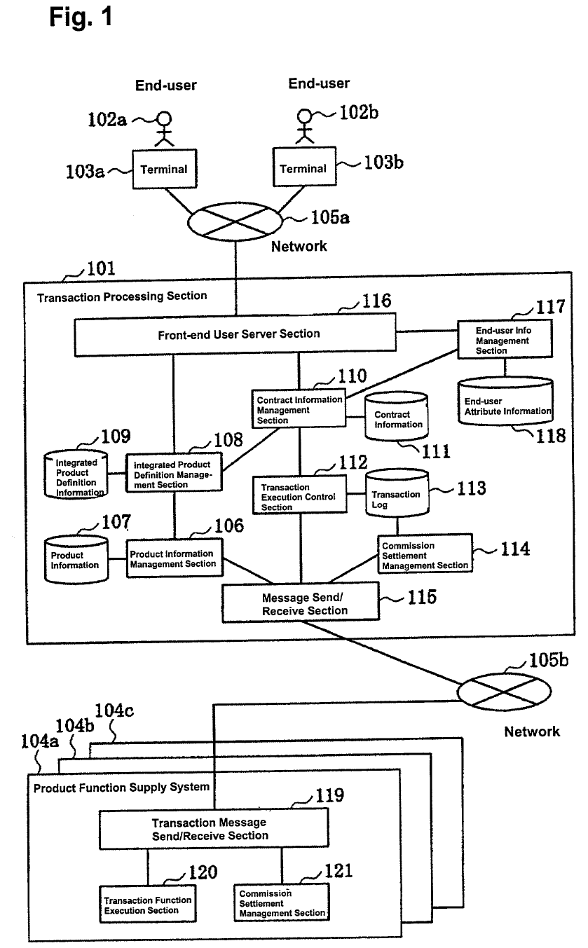

FIG. 1 is a block diagram showing an example of the structure of a product brokerage transaction processing system in accordance with an embodiment of the present invention.

The product brokerage transaction processing system in FIG. 1, particularly, mediates financial products offered by multiple financial institutions and consists of a transaction product system 101 which is set up at a brokerage institution, terminals 103a-103b which are used by multiple end-users 102a-102b, and networks 105a-105b which connect the systems and terminals described above. Although this embodiment example shows two terminals, two end-users and two networks, the system may involve any number of (preferably two or more) terminals, users and networks.

Each of the terminals 103a-103b used by the respective end-users 102a-102b sends and receives messages to and from the transaction processing system 101, displays information from the transaction system 101, inputs contents of a transaction request by the end-user, and sends the transaction request to the transaction processing system 101.

The transaction processing system 101 is a system which receives the transaction request from any of the terminals 103a-103b used by the end-users 102a-102b, and executes an corresponding transaction. The transaction processing system 101 includes a product information management section 106, an integrated product definition information management section 108, a contact information management section 110, an end-user information management section 117, a transaction execution control section 112, a message send/receive section 115, a commission settlement management section 114, and a front-end server section 116.

The product information management section 106 manages information of the products offered by product function offering systems 104a, 104b and 104c, and corresponds to inquiries for product information in the transaction processing system 101 by maintaining the information of the products expressed in the form of product information 107 and returning the product information matching specified conditions. Although this embodiment example shows three product function offering systems, the system may involve any number of (preferably two or more) product function offering systems.

The integrated product definition information management section 108 expresses a collection of transactions each consisting of multiple products as integrated products, and expresses and maintains a collection of transaction definitions as an integrated product definition information 109.

The transaction processing system 101 in this embodiment expresses an integrated product according to a model which has a collection of multiple work flows performing services. The integrated product definition information management section 108 expresses and maintains in the form of the integrated product definition information 109, and responds to inquiries for the integrated product definition information in the transaction processing system 101 by returning the integrated product definition information matching specified conditions.

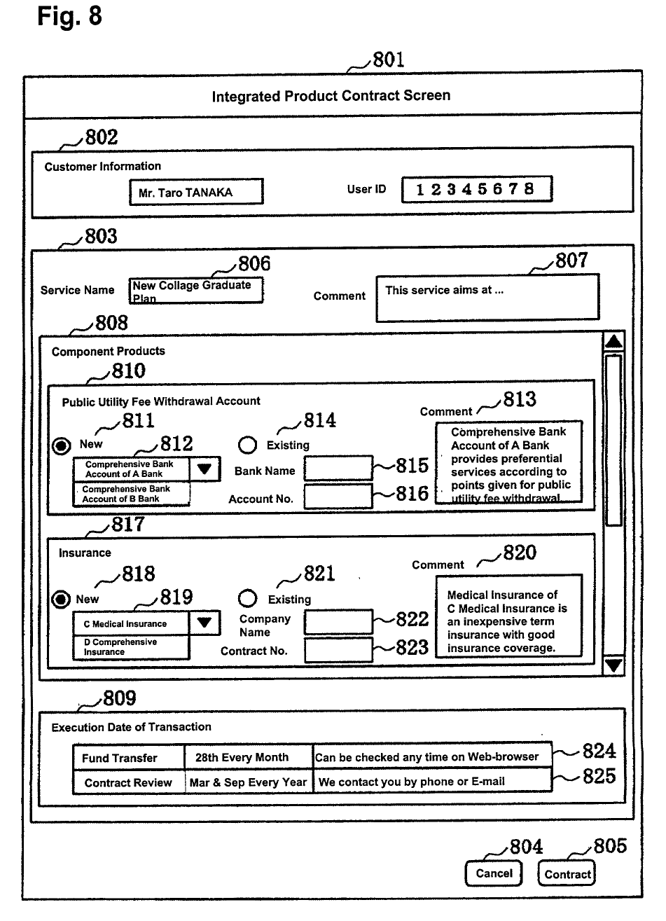

The contract information management section 110 manages information indicating any of the end-users 102a-102b has entered a contract for at least one integrated product. The contract here means a contract to perform a transaction for an integrated product, and contents of the contract consist of information such as the timing, and amount for the transaction for which of the products. The details will be described in FIGS. 8-10 below. Also, the contract information management section 110 expresses and maintains the contract contents as contract information 111 and responds to inquiries for the contract information in the transaction processing system 101 by returning the contract information matching specified conditions.

The end-users information management section 117 manages attribute information (names, etc.) of the end-users 102a-102b, maintains, as end-user attribute information 118, the attribute information such as names and addresses of the end-users and identification information such as the passwords necessary when executing a transaction for each product which forms an integrated product to be used by the end-users, and uses appropriate information according to requests from the transaction execution control section 112 when executing a transaction.

The transaction execution control section 112 executes a transaction process according to the contract information 111 and the integrated product definition information 109. It also performs a transaction for each product which forms an integrated product by sending a transaction message that is prepared by the transaction execution control section 112 based on the contract information 111 and the integrated product definition information 109 to the product function offering systems 104a, 104b and 104c of applicable financial institutions through the message send/receive section 115.

The product function offering systems 104a, 104b and 104c each receive a transaction message from the transaction processing system 101 at a message send/receive section 119, and processes an applicable transaction at a transaction function execution section 120.

The transaction execution control section 112 in the transaction processing system 101 obtains necessary information regarding end-users such as the password from an end-user information control section 117 while executing a transaction. It also outputs and records details of the transaction execution in a transaction log 113.

The message send/receive section 115 sends and receives a message for the transaction processing system 101 as a brokerage institution with respect to the product function offering systems 104a, 104b and 104c of multiple financial institutions.

In addition, the commission settlement management section 114 calculates the commission amount based on the contents of the transaction log 113, performs a settlement at the calculated amount of commission with the commission settlement management section 121 of each of the product function offering systems 104a, 104b and 104c at the respective financial institutions, and sends a billing message consisting of the commission details to each corresponding one of the product function offering systems 104a, 104b and 104c at the respective financial institutions after accumulating the commission details for each financial institution.

Then, the front-end server section 116 in the transaction processing system 101 provides the terminals 103a-103b used by the end-users 102a-102b with an interface of the transaction processing system 101. It sends display screen information displayed at the terminals 103a-103b, and retrieves an applicable function in the transaction processing system 101 by analyzing the message contents received from the terminals 103a-103b.

Next, a description will be made as to the outline for executing a transaction in the product brokerage transaction processing system which is structured in a manner described above.

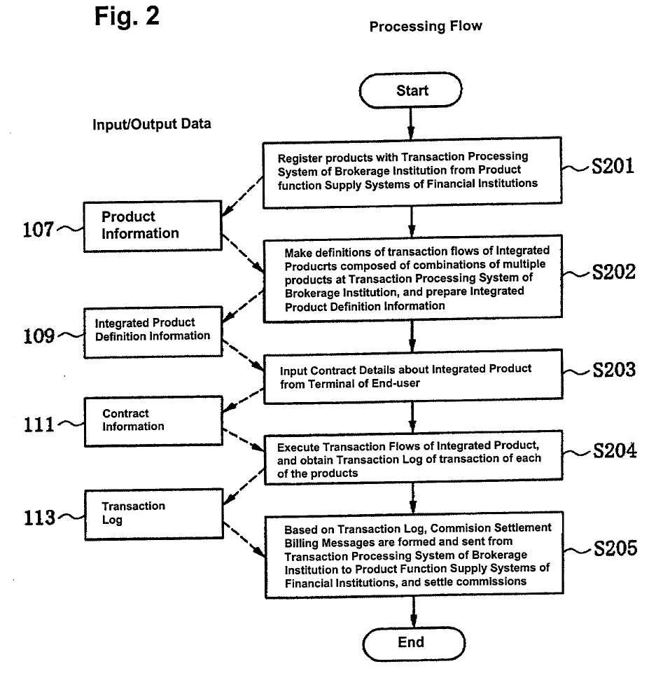

FIG. 2 is a flow chart showing an example of the processing operations related to a product brokerage transaction processing method of the present invention in the product brokerage transaction processing system in FIG. 1.

First, each financial institution registers its financial products that it will offer with a brokerage institution. In other words, each financial institution requests, from the corresponding one of the product function offering systems 104a, 104b and 104c to register by sending the information that it will offer to the transaction processing system 101 at a brokerage institution, which prepares and maintains product information 107 based on the product information received (step S201).

Next, the brokerage institution, based on the registered products, designs and develops an integrated product (or integrated products each) consisting of a combination of multiple products. In other words, it defines a work flow to compose each integrated product at the integrated product definition information management section 108 of the transaction processing system 101 in FIG. 1, and prepares and maintains integrated product definition information 109 based on the product information 107 which each institution offers (step S202).

When any of the end-users 102a-102b using the terminals 103a 103b accesses to the transaction processing system 101, refers to information of the integrated products, and inputs contract details, the transaction processing system 101 maintains the input contract details as contract information 111 using the contract information management section 110 (step S203). This contract information 111 contains trigger event parameter information indicating triggers to execute the transaction flow.

When a trigger event occurs, the transaction processing system 101 executes the applicable transaction flow using the transaction execution control section 112. In other words, it sends/receives a transaction message according to the product information 107 which was registered, during product registration, for transaction of each of the products that form the applicable transaction flow. Then it performs a transaction and maintains information indicating the execution of the transaction in a transaction log 113 (step S204).

Furthermore, the transaction processing system 101 refers to this transaction log 113, prepares a commission settlement message using the commission settlement control section 114, sends it to each of the product function offering systems 104a, 104b, 104c, . . . of the financial institutions, and performs a commission settlement (step S205).

With the processes described above, at the product brokerage transaction processing system in the embodiment example, the registration of products from financial institutions only requires the registration of information on the basic system already prepared in advance, which is easier compared to the conventional method where financial institutions independently tie-up among themselves or develop a transaction processing system.

In addition, an integrated product can be generated by combining registered product information to thereby define a work flow, which is easier compared to the conventional method where each financial institution builds a new transaction processing system.

Furthermore, a contract entered by the end-user related to the integrated product is to specify parameters of a work flow of the integrated product, which is easier compared to the conventional method where a contract is entered with multiple financial institutions.

Also, this system has a infrastructure for commission settlement and is based on the parameter information during product registrations, thus is easier to construct a commission settlement system than the conventional method where commissions are determined among financial institutions individually.

As noted above, the system can easily offer integrated products each consisting of a combination of products offered by multiple financial institutions. Therefore, it can offer integrated product services promptly to end-users.

Next, the transaction processing system 101 at brokerage institutions will be further described in detail.

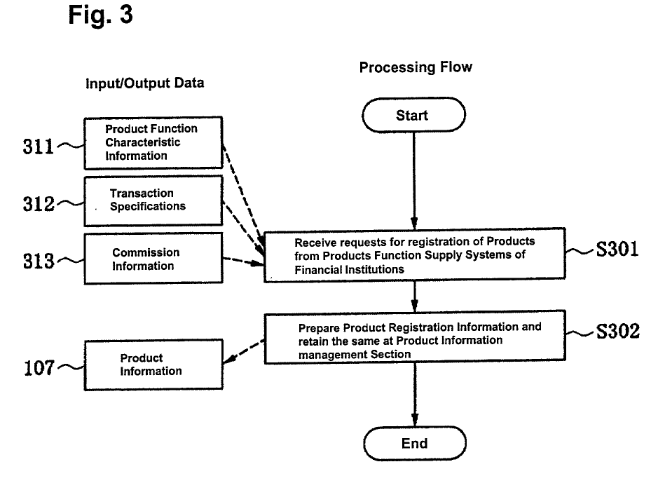

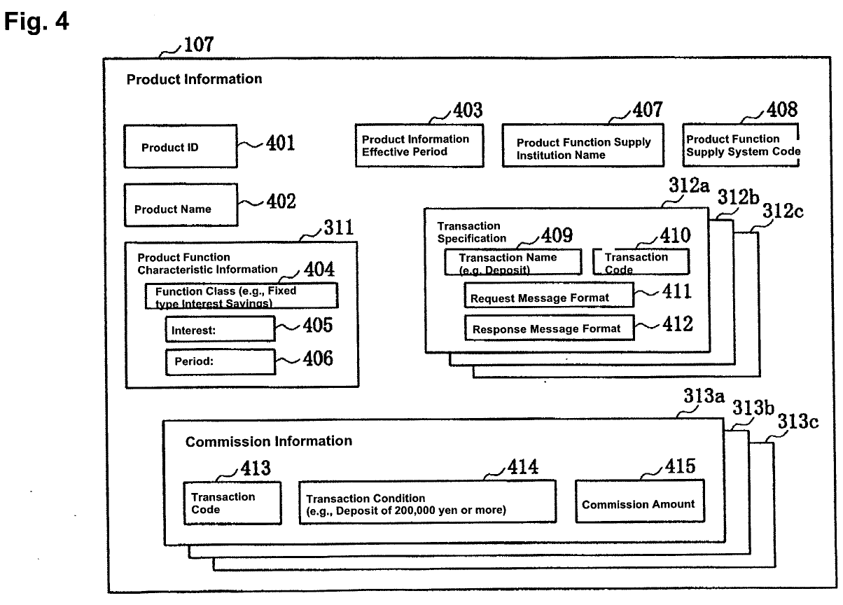

FIG. 3 is a flow chart showing an example of the process operations in the product maintenance section at the transaction processing system in FIG. 1. FIG. 4 is a drawing explaining the structure of product information prepared and maintained by the processes in FIG. 3.

The processes in FIG. 3 show an example of the processes performed at the transaction processing system 101 in FIG. 1 when financial institutions register their financial products with a brokerage institution. First, the transaction processing system 101 receives a registration request for at least one financial product (ordinarily, multiple financial products) sent from each of the product function offering systems 104a, 104b and 104c (step S301) of the financial institutions.

The registration request received in such a manner contains product function characteristic information 311 indicating product function characteristics, a transaction specification 312 indicating a specification of transaction regarding the product, and commission information 313 indicating information about commission that the financial institution pays to the brokerage institution.

The transaction processing system 101, which received the product registration requests from the product function offering systems 104a, 104b, 104c, . . . prepares and maintains product information 107 at the product information management section 106 (step S302). The product information 107 prepared is shown in FIG. 4.

With the process described above, only by registering product function attributes and parameter information such as transaction message specifications on the base of the transaction processing system 101, product brokerage can be easily done at the brokerage institution instead of the conventional system in which financial institutions make operational tie-ups individually. Furthermore, by registering information about products per se together with commission information at the same time, the process becomes more simple and easier than the conventional method where commissions are arranged separately from a system for product transactions.

FIG. 4 shows a structure of the product information 107 maintained at product information management section 106, and details for the product information 107 will be described below with reference to FIG. 4.

A product ID 401 is an ID exclusively identifying a corresponding product in the transaction processing system 101. The product ID 401 is used as a condition with this ID being a “key” when products are associated with integrated products or product information are referred.

A product name 402 is a name identifying each applicable product in the transaction processing system 101, and is used when displaying the product in the terminals 103a-103b used by the end-users 102a-102b.

A product information effective period 403 indicates a period when applicable product information is effective, and is used to specify product information that is effective when preparing commission details according to the transaction log 113 during the product execution.

Product function characteristic information 311 indicates information for the function characteristic of an applicable product, and consists of, for example, a function classification 404 (for example, fixed interest deposits), an interest rate 405, a period 406, etc.

A product offering institution name 407 indicates a name of a financial institution offering an applicable product, and is used when displaying in the terminals 103a-103b used by the end-users 102a-102b, and when setting up the name of financial institution recorded in the log during the preparation of the transaction log 113.

A product function offering system code 408 indicates a code specifying each of the product function offering systems 104a, 104b and 104c which offer transaction functions of the products, and the message send/receive section 115 sends a transaction message using the code to the corresponding one of the product function offering systems 104a, 104b and 104c.

Transaction specifications 312a, 312b and 312c (only three are shown as an example, but can be any number) indicate information of message specification when performing a transaction composed of an applicable product, and each consists of a transaction code 409, a transaction name 410, a request message format 411, a respond message format 412, etc. This message format can be a format specified by the IFX (Interactive Financial Exchange) or the like.

Commission information 313a, 313b and 313c (only three are shown as an example, but could be any number) each indicate information for the rules regarding exchanging commissions between the financial institutions offering applicable products and the brokerage institution, and each consist of a group of a transaction code 413, a transaction condition 414, and a commission amount 415. For example, the commission information 313a, 313b and 313c provides information for the commission rules as follows.

### EXAMPLE 1

When an end-user deposits fund in the bank account for an applicable product, and the condition is deposits over 200,000 yen, 50 yen would be the commission that a financial institution offering the product pays a brokerage institution.

### EXAMPLE 2

When an end-user enters a contract for the product or opens an account (transaction name: account open, transaction code: A001), 100 yen would be the commission that a financial institution offering the product pays a brokerage institution. There is no transaction condition.

As noted above, by expressing product information according to the predetermined format, it will be easier to register financial products from financial institutions to a brokerage institution.

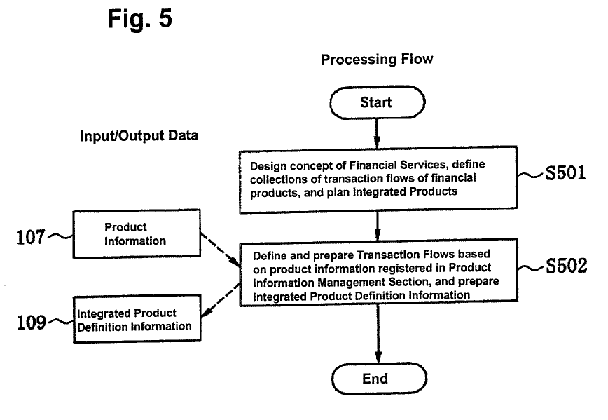

Next, referring to FIGS. 5 through 7, a description will be made as to operations to prepare integrated products according to the product information 107 which is prepared and maintained at the product information management section 106.

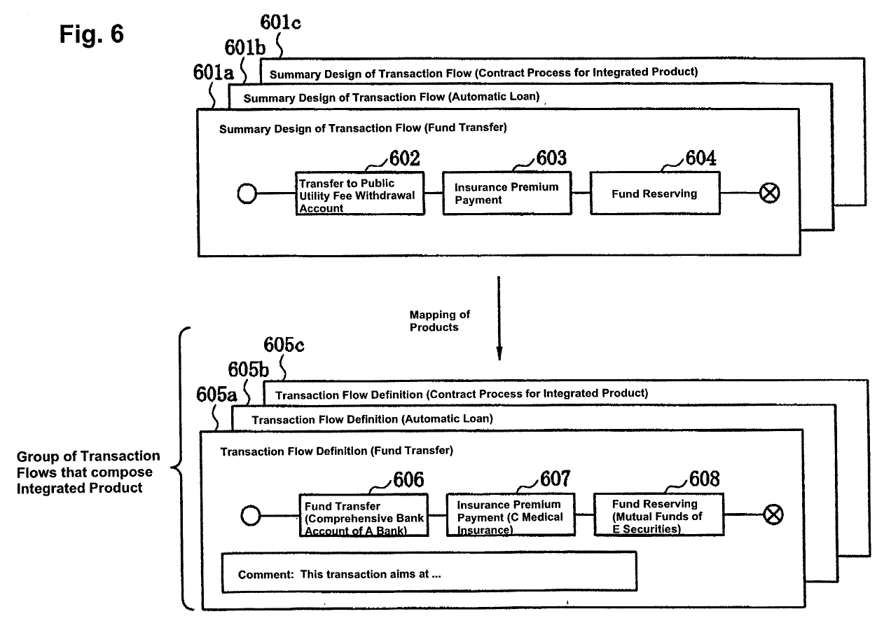

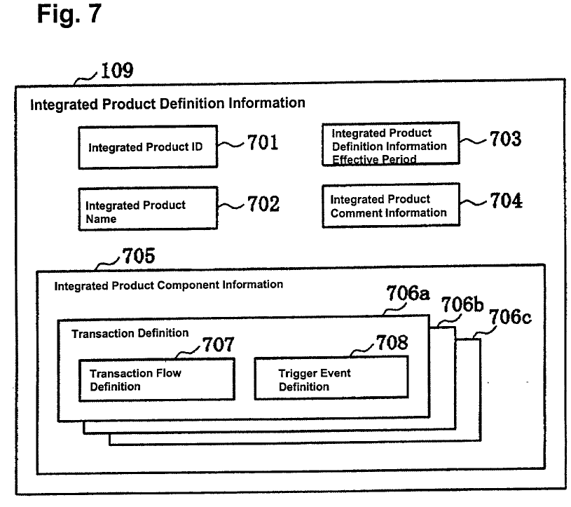

FIG. 5 is a flow chart showing an example of the preparation processing operations of integrated product in transaction processing system in FIG. 1. FIG. 6 is a drawing explaining an example of the integrated product preparation processing operation in FIG. 5. FIG. 7 explains an example for the structure of integrated products prepared in the integrated product preparation processing operation in FIG. 5.

At the processes in FIG. 5, a brokerage institution first designs a concept of comprehensive financial services to be offered to end-users, defines a combination of multiple financial products and a collection of transaction flows of financial products, and prepares a plan for integrated products (step S501).

Next, according to this plan, the brokerage institution refers to the product information 107, and puts together a collection of the definitions of transaction flows and a combination of products which compose the transaction flows and expresses them as integrated product definition information 109 (step S502). Also, when composing the integrated product, it includes comments such as reasons (for composing the integrated product) in the integrated product definition information 109.

An example of the development for these integrated products is shown in FIG. 6. A brokerage institution designs a summary of transaction flows offering services with integrated products from the integrated service concept, matches the product information 107 registered from each financial institution based on summary designs 601a, 601b and 601c (only three are shown as an example, but could be any number) of the transaction flows designed, and prepares definition information (transaction flow definitions 605a, 605b and 605c) as an example of the transaction flow. Furthermore, it includes reasons for selecting each product as additional information (“comment”) when structuring the transaction flow definitions 605a, 605b and 605c as noted above.

For example, one wants to offer comprehensive financial services to new college graduates. These financial services to new college graduates may include a balance transfer from a salary deposit bank account to an expense (such as public utility fees) withdrawal bank account (602), a payment of insurance premium (603), a fund reserving (604) and the like.

As for the expense (e.g., public utility fees) withdrawal, a comprehensive bank account at A Bank has preferential services based on points corresponding to withdrawal transactions, and is included in the structure of an integrated product combination by selecting this product as it has more advantage to end-users than other financial institutions (606).

As for the insurance premiums, it may determine that it is appropriate to increase one's savings first and selects term medical insurance by C Insurance Company, which has no premium at the end of the term, and therefore has a lower premium (607). And, as for the fund reserving, it may assume that one will have a stable income and he will need funds in 5 years, and based on this assumption selects mutual funds by E Securities which he can expect higher returns despite higher risks (608).

Other than that, it may assume that new college graduates do not have much deposit, and registers automatic loans with savings account as a collateral in the transaction flow (605b).

This concept planning and product selection can be performed based on determinations by a financial planner at a brokerage institution or results obtained from the analyses by CRM (Customer Relationship Management) systems. Also, inputs of definition information as integrated products can be done by system operators at a brokerage institution.

Also, a transaction flow (605c) that takes place when an end-user enters a contract for the integrated product may be defined while the integrated product is developed. This process flow is assumed to expedite inputting contract contents for each product composing the integrated product. Input screens matching the process flow can be displayed, such that the end-users can input contract contents in the terminals 103a-103b used by the end-users 102a-102b.

Integrated products developed and prepared as above are managed as the integrated product definition information 109 using the structure shown in FIG. 7. In the integrated product definition information 109 shown in FIG. 7, an integrated product ID 701 is an ID (identification) to identify each applicable integrated product in the transaction processing system 101 at the brokerage institution, and this ID is used as a key, or as conditions for associating the integrated products with contract information of the end-users and matching integrated product definition information.

Furthermore, an integrated product name 702 is a name identifying each of the integrated products in the transaction processing system 101, and is used to display the integrated product in the terminals 103a-s 103b used by the end-users 102a-102b.

An integrated product definition information effective period 703 indicates a period in which the integrated product definition information is effective, and is used to specify the integrated product definition information which becomes effective when commission details are prepared according to the transaction execution timing and the transaction log 113, which will be explained later.

Integrated product comment information 704 is information explaining the integrated product, and is used to display the integrated product in the terminals 103a-103b used by the end-users 102a-102b.

Integrated product composition information 705 indicates a composition of each integrated product, and consists of a collection of transaction flows 706a, 706b and 706c (only three are shown as an example, but could be any number). Each of the transaction flows 706a, 706b and 706c consists of a combination of a transaction flow definition 707 and a trigger event definition 708. The combination shows that what event will trigger what type of transaction. For instance, it may show that a series of transaction flows such as balance transfer and insurance premium payment will be executed on the 28th of every month when a salary is deposited.

Next, with reference to FIGS. 8-10, a description will be made as to a process executed when offering an integrated product developed and prepared as noted above.

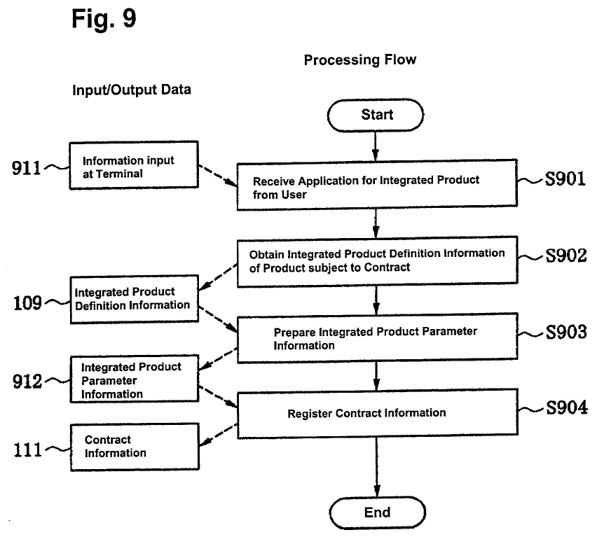

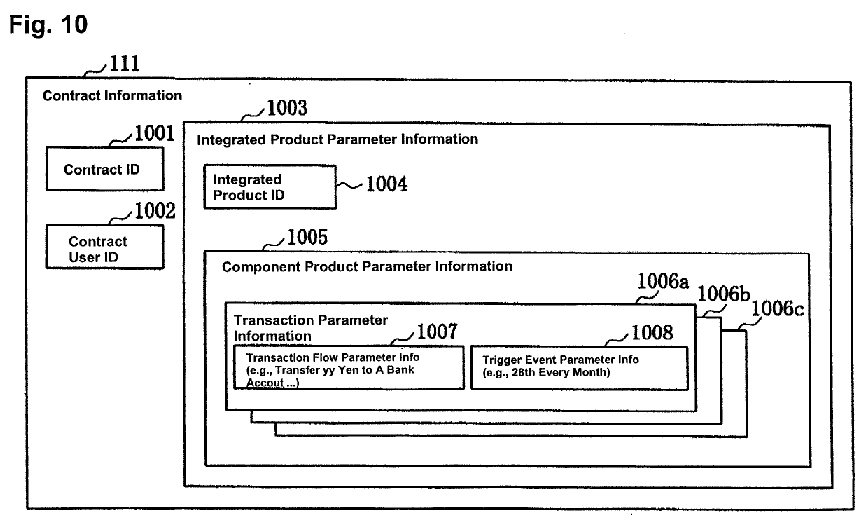

FIG. 8 explains a composition example of a display screen used for a contract of an integrated product displayed in the end-users' terminal in FIG. 1. FIG. 9 is a flow chart showing an example of the processing operations by the contract information management section of the transaction processing system in FIG. 1. FIG. 10 explains an example of the composition of the contract information processed in FIG. 9.

An integrated product contract screen 801 shown in Fig.8 consists of a window image displayed in any of the terminal 103a-103b used by the end-users 102a-102b, and may be displayed on a web-browser.

This integrated product contract screen 801 consists of an area 802 indicating customer information, an area 803 indicating product information of integrated products, a “Cancel” button 804, and a “Contract” button 805.

The area 802 indicating customer information shows the attribute information of an end-user entering the contract, and the information contents are based on the information registered in the end-user information management section 118 in FIG. 1. Such information is requested for registration with a brokerage institution in advance. The information is acquired when logging-in to use the transaction processing system 101 from any of the terminals 103a-103b. The registration and maintenance of end-user attribute information, and acquisition of the same at log-in can employ the technologies realized by a commonly used system with a Web server and a Web browser client.

The area 803, which indicates product information of integrated products, consists of an item 806, which displays a name of the integrated product, an item 807, which displays a comment, and an area 808, which specifies details of each financial product composing the integrated product.

In addition, the item 807, which displays comments, indicates a comment for the integrated product. Any of the end-users 102a-102b refers to the comment, understands the characteristics of this integrated product, and utilizes it for making contract-related decisions.

Also, the area 808 consists of areas 810 and 817, which indicate component products, and an area 809, which indicates transaction event set ups. The area 810 receives, for example, an input specifying a utility expense withdrawal account, which is a component of this integrated product, in the following manner.

When an end-user newly opens an account, he selects “New” at an item 811, and selects a product from an item 812. The product displayed in the item 812 is a product which has a functional attribute matching to one of those of the product information 107 shown in FIG. 4 that is registered in the product information management section 106 shown in FIG. 1. The end-user can select such a product depending on his preference.

Also, a comment for the selected product is displayed in an item 813, and can be used for the end-user's decision-making when selecting products.

If the end-user uses an existing bank account he already has, he selects “Existing” at an item 814, and specifies the existing bank account by inputting the bank name in an item 815, and the account number in an item 816.

An area 817 receives an input specified by the insurance product composing this integrated product. when an end-user newly enters a contract, he selects “New” at an item 818, and selects a product from an item 819. The product displayed in item 819 is a product which has a functional attribute matching to one of those of the product information 107 in FIG. 4 which is registered in the product information management section 106, and the end-user can select such a product depending on his preference. Also, a comment for the selected product is displayed in an item 820, and can be used for the end-user's decision-making when selecting products.

If an end-user uses an existing account he already has, he selects “Existing” at an item 821, and specifies the existing account by inputting the insurance company name in an item 822, and the contract number in an item 823.

Similarly, inputs are made to specify each of the products contained in the area 808 for each of the products composing this integrated product.

An area 809 indicates a transaction event set-up, and consists of transaction flows composing this integrated product and items specifying a combination of events which become a trigger to execute these transaction flows. For example, it specifies to execute an automatic fund transfer on 28th of every month (824) and a review of the contract in March and September every year (825).

As an event to review the contract noted above, it may specify something regular such as every March, and something along the life cycle such as a marriage plan set-up, house purchase plan set-up, and child birth. Also, information on events for the life cycle is maintained synchronized with the contents of the end-user attribute information 118 in the end-user information management section 117.

Information on this screen will be deleted by pushing the cancel button 804, and the contract information 111 in the transaction processing system 101 will not be changed. Also, by pushing the contract button 805, information on this panel will be sent to the transaction processing system 101, and is kept as the contract information 111 in the contract information management section 110.

In addition, before finalizing the contract information, the contract contents received by the transaction processing system 101 can be displayed in the terminal (103a-103b) Then, after the end-user (102a-102b) confirms the contents, the contract information 111 can be finalized if the terminal (103a-103b) sends an approval.

By using the screen composed in a manner shown in FIG. 8, an end-user can enter a contract after he selects products on his judgment from the products registered with the brokerage institution and composes an integrated product.

In addition, an end-user can easily know comprehensive financial services which a financial planner, etc. designed in advance, and use them for making a contract decision. Furthermore, one can review the contract in a timing appropriate for the user based on his life cycle and change the contract contents.

With reference to FIG. 9, a description will be made as to preparation/processing operations for the contract information 111 of integrated products by the contract information management section 110 in the transaction processing system 101 based on operations of the contract screens.

First, the contract information management section 110 in the transaction processing system 101 in FIG. 1, receives a request for an integrated product contract from the terminal (103a-103b) used by the end-user (102a-102b) via the front-end server section 116, and obtains terminal input information 911 which is input at the screen 801 shown in FIG. 8.

Next, the system, using the integrated product name obtained at the step S901 as a key, obtains the integrated product definition information 109 from the integrated product definition information management section 108 (step S902), prepares a combination of parameter information in the transaction flow and that in the trigger event, and prepares integrated product parameter information 912 (step S903). Based on the integrated product parameter information 912, contract information 111 is prepared (step S904).

The contract information 111, which was prepared in the contract information management section 110 in the transaction processing system 101 in such a manner, consists of a contract ID 1001, a contract user ID 1002, and integrated product parameter information 1003 as shown in FIG. 10.

The contract ID 1001 of the contract information 111 in FIG. 10 is an ID identifying the applicable contract in the transaction processing system in FIG. 1. The contract user ID 1002 is an ID to identify the end-user who entered the applicable contract, and is used, with this ID being a key, to obtain attribute information of the end-user by the end-user information management section 117 in the transaction processing system 101.

Furthermore, the integrated product parameter information 1003 of the contract information 111 consists of an integrated product ID 1004 and parameter information 1005, and the integrated product ID 1004 is an ID identifying integrated products of the applicable contract. This ID is used as a key when obtaining the integrated product definition information 109 from the integrated product management section 108 in the transaction processing system 101.

Also, the product component parameter information 1005 of the contract information 111 consists of transaction parameter information 1006a, 1006b and 1006c (only three are shown as an example, but could be any number), each of which consists of transaction flow parameter information 1007 and trigger event parameter information 1008, and maintains the contents input in the contract screen in FIG. 8 as a parameter.

In addition, when the end-user (102a-102b) enters a contract for this integrated product, information such as reasons why he selected the integrated product may be maintained in the integrated product parameter information 1003, and the contract may be reviewed or supports for sales activity may be provided through analyzing the reasons with CRM system or the like.

Next, a description will be made as to processes to execute a transaction for integrated products using an event as a trigger based on the contract information 111 in FIG. 10.

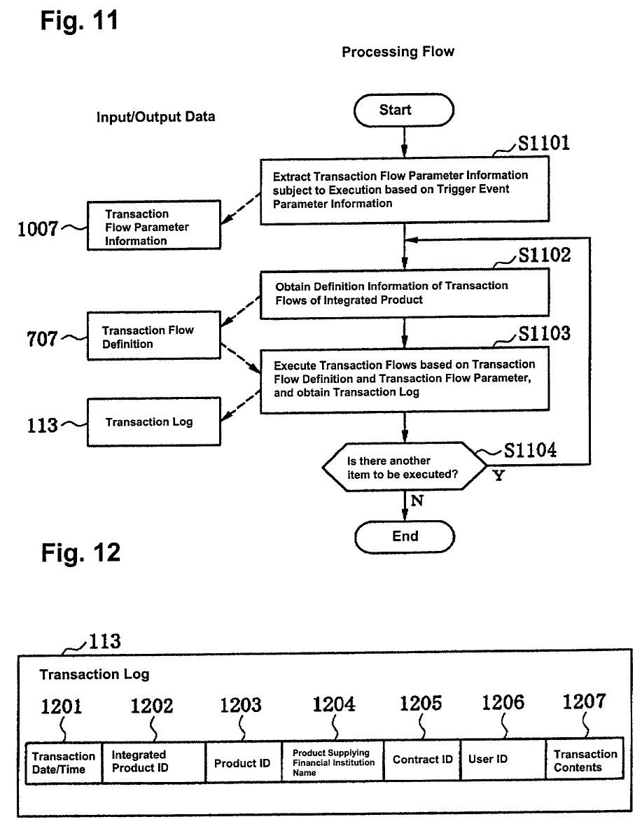

FIG. 11 is a flow chart showing an example of the transaction execution processing operations for integrated products performed by the transaction processing system in FIG. 1.

First, the transaction processing system 101 searches the trigger event parameter information 1008 composing the contract information 111 in FIG. 10 using the time of execution of this process as a key. Then, it extracts the parameter information 1007 of the transaction flows to be executed, which matches the trigger events (step S1101).

Next, for one of the transaction flows extracted at step S1101, it obtains definition information 707 for the transaction flow of integrated product in shown in FIG. 7 from the integrated product definition information 109 using the integrated product definition information management section 108 (step S1102).

Based on the obtained definition information 707 for the transaction flow and the parameter information 1007 for the transaction extracted at step S1101, the transaction execution control section 112 executes the transaction flow (step S1103). For example, the transaction flow may consist of transaction steps of money transfer to a public utilities expense account, payment of an insurance premium, purchase of mutual funds, etc.

A transaction message for each of the transaction steps is sent to each corresponding one of the product function offering systems 104a, 104b and 104c of the respective financial institutions, and each of the transaction steps is performed by the respective transaction function execution section 120. Also, when executing each of the transaction steps, detail information of the transaction is output to the transaction log 113.

At step S1104, a determination is made as to whether or not any transaction to be executed may still remain among the ones extracted at step S1101. When any unexecuted transaction remains, such a transaction is obtained, and the process returns to step S1102, and the steps at steps S1102 and S1103 are repeated until all of the transactions, which are subject to execution at the time of executing the present process, are executed.

Also, while extracting transactions to be executed at step S1101, the system may record the time as well as changes, if any, in the attribute information 118 of the end user, in the event parameter information in the contact information 111 to indicate that the changes have been made, and the transaction flow to be executed can be extracted based on that record.

Next, a description will be made as to an outline of processes of commission settlement between a brokerage institution and financial institutions in the product brokerage transaction process system in FIG. 1.

The system performs a commission settlement by preparing detail information of the commission settlement extracted from the transaction log 113 in FIG. 1, then preparing a commission billing message for each financial institution based on the detail information, and sending the commission billing message to a corresponding one of the product function offering systems 104a, 104b and 104c at the respective financial institutions.

FIG. 12 is a drawing explaining details of log record which is recorded in the transaction log in FIG. 1.

The transaction log 113 consists of a transaction date and time 1201, an integrated product ID 1202 used to identify each integrated product subject to transaction, a product ID 1203 used to identify each product subject to transaction, a product offering institution name 1204, a contract ID 1205, a user ID 1206 to identify each end-user who used transaction services, and a transaction content 1207.

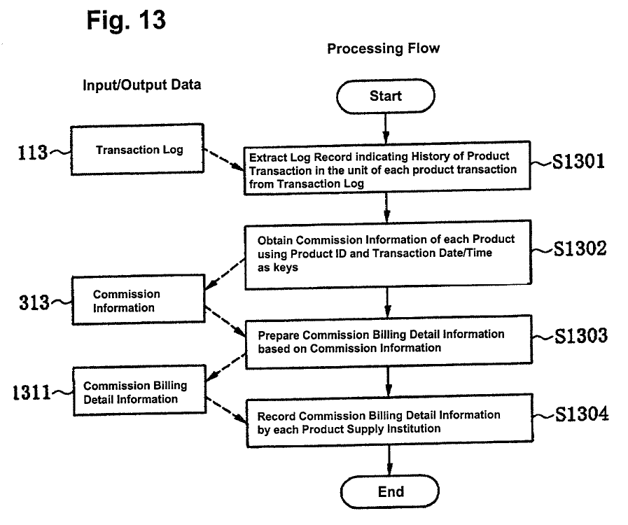

FIG. 13 is a flow chart showing an example of processing operations where commission settlement detail information is extracted at the commission settlement management section in FIG. 1.

First, the commission settlement management section 114 in FIG. 1 extracts one log record showing a transaction history in the unit of a single transaction from the transaction log 113 (step S1301), obtains applicable product information from the product information 107 in FIG. 4, using the product ID 1203 and the transaction date and time 1201 contained in the extracted information (transaction log record in FIG. 12) as a key, and obtains commission information 313a-313c from the obtained product information (step S 1302).

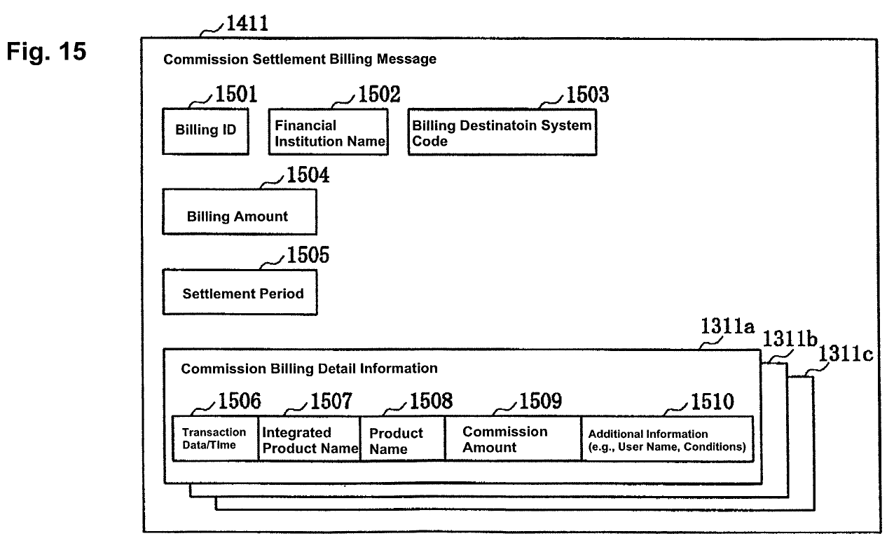

Next, commission billing detail information 1311 per transaction (to be described below with reference to FIG. 15) is prepared based on the obtained commission information 313a-313c (step S1303), and the commission billing detail information 1311 is recorded after being allocated to a storing area for each of the financial institutions using the financial institution name 1204 in the log record in FIG. 12 as a key (step S1304).

By doing so, the efficiency is improved in commission settlement when preparing a billing message for commission settlement per each financial institution, compared to maintaining the commission billing detail information 1311 regardless of financial institutions.

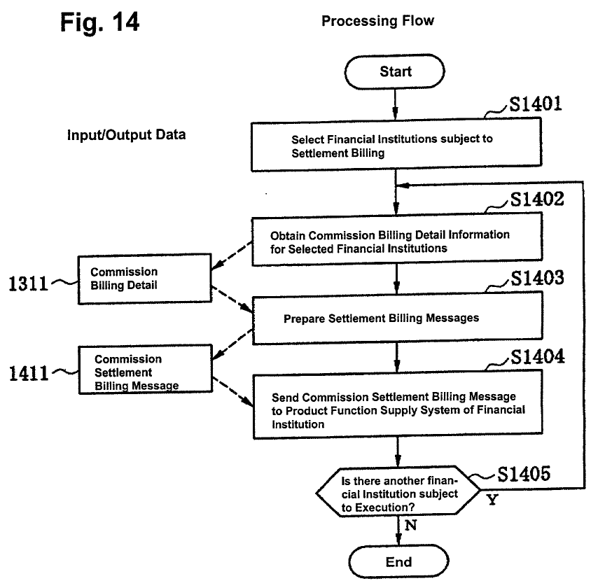

FIG. 14 is a flow chart showing an example of the processing order for settling commissions in the transaction processing system in FIG. 1.

In this processing, the period when transactions subject to commission settlement are executed is specified. For example, the processing is to be executed at 19:00, and transactions performed from 8:00 to 18:00 on a specified date are designated to be subject to settlement.

With the designation above, the transaction processing system 101 in FIG. 1 selects financial institutions subject to the settlement billing message preparation (step S1401), and extracts the selected commission billing detail information 1311 for the period specified by the input (step S1402).

As for the search condition for each of the financial institutions, the corresponding storing area can be specified for selection because the storing areas for the commission billing detail information 1311a, 1311b and 1311c (only three are shown as an example, but could be any number) are set up for each financial institution as described below with reference to FIG. 15. As for the search conditions for periods, the transaction date and time 1506 contained in the commission billing detail information shown in FIG. 15 is used as a key for selection to obtain all applicable commission billing detail information 1311a, 1311b and 1311c.

Next, all of commission billing detail information 1311a, 1311b and 1311c are collected, a commission settlement billing message 1411 is prepared (step S1403), and the prepared commission settlement billing message 1411 is sent to the corresponding one of the product function offering systems 104a, 104b and 104c at the respective financial institutions (step S1404). In other words, the message is sent to the corresponding one of the product function offering systems 104a, 104b and 104c via the message send/receive section 115 based on the product function offering system code 408 contained in the product information 107 shown in FIG. 4.

Then, a determination is made as to the existence of other financial institutions subject to the settlement (step S1405). If there is any, the process returns to step S1401, repeats the steps described above, and sends commission settlement billing messages to all of the financial institutions.

FIG. 15 is a drawing to explain the structure of the commission settlement billing message prepared in the processing in FIG. 14.

The commission settlement billing message 1411 consists of a billing ID 1501, a financial institution name 1502, a billing destination system code 1503, a billing amount 1504, a settlement period 1505, and commission billing detail information 1311a, 1311b and 1311c. The billing ID 1501 is an ID to identify the applicable billing message.

Also, the financial institution name 1502 is a name of financial institution where the billing message is sent, the billing destination system code 1503 is a system code which specifies the system which answers to the commission settlement in response to the billing message. Based on this code, the message send/receive section 115 in the transaction processing 101 in FIG. 1 sends the billing message to the applicable product function offering systems 104a, 104b-104c. In addition, the billing amount 1504 indicates the amount of commission settled in this billing, and the settlement period 1505 indicates the period subject to this billing.

Furthermore, each of the detail information 1311a, 1311b and 1311c is a collection of detail information indicating each transaction and the commission amount for the transaction subject to this billing, and consists of a transaction date and time 1506, an integrated product name 1507, a product name 1508, a commission amount 1509 for this transaction, and other additional information 1510 (e.g., end-user name and condition).

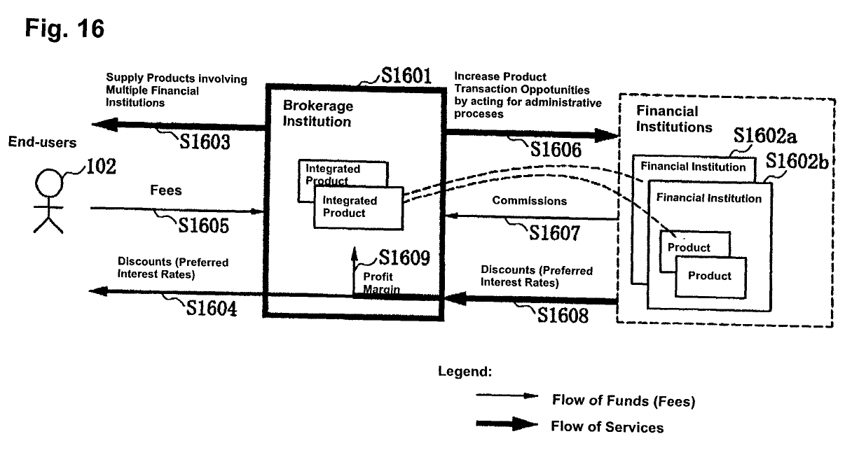

With reference to FIG. 16, a description will be made as to an example of the business models in the financial product transaction processing system with the above structure and operations.

FIG. 16 is a drawing to explain an example of the product transaction operations in the product brokerage transaction processing system in FIG. 1.

FIG. 16 is a model to show that a brokerage institution S1601 which intermediates and processes combinations of products of multiple financial institutions can exist as a business. First, the relationship between the brokerage institution 1601 and the end-user 102 will be described.

The brokerage institution 1601 offers to the end-user 102 comprehensive financial services across multiple financial institutions 1602a and 1602b, in the form that can be readily used (step S1603). In this example, only two financial institutions are shown as an example. However, the present invention is also applicable to any number of financial institutions.

Also, if the brokerage institution 1601 can receive discount services such as a preferred interest rate due to the scale merit obtained when offering product functions from the financial institutions 1602a and 1602b, the brokerage institution 1601 may offer the same discount services to the end-user 102 (step S1604).

For these services provided, the end-user 102 will pay fees to the brokerage institution 1601 (step 1605). The end-user 102, however, may not have to pay the fees if the brokerage institution 1601 receives sufficient commission income, etc. from the financial institutions 1602a and 1602b, which will be explained later.

Next, the relationship between the brokerage institution 1601 and the financial institutions will be described. The brokerage institution 1601 provides services which enhance transaction opportunities to the financial institutions 1602a and 1602b such that the end-user 102 can easily use financial products offered by each financial institution. In addition, the brokerage institution 1601 provides services to take over administrative tasks that financial institutions are performing by becoming a contact point with end-users (step S1606).

For this service received, the financial institutions 1602a and 1602b pay commissions (step S1607) or provide discounts such as preferred interest rates (step S1608).

Then the brokerage institution 1601 earns a profit margin from the difference between discounts from the financial institutions 1602a and 1602b and those to the end-user 102 (step S1609).

As a result, a “Win-Win-Win” business model can be structured, where the end-user 102, the brokerage 1601, and the financial institutions 1602a and 1602b all have their own advantages.

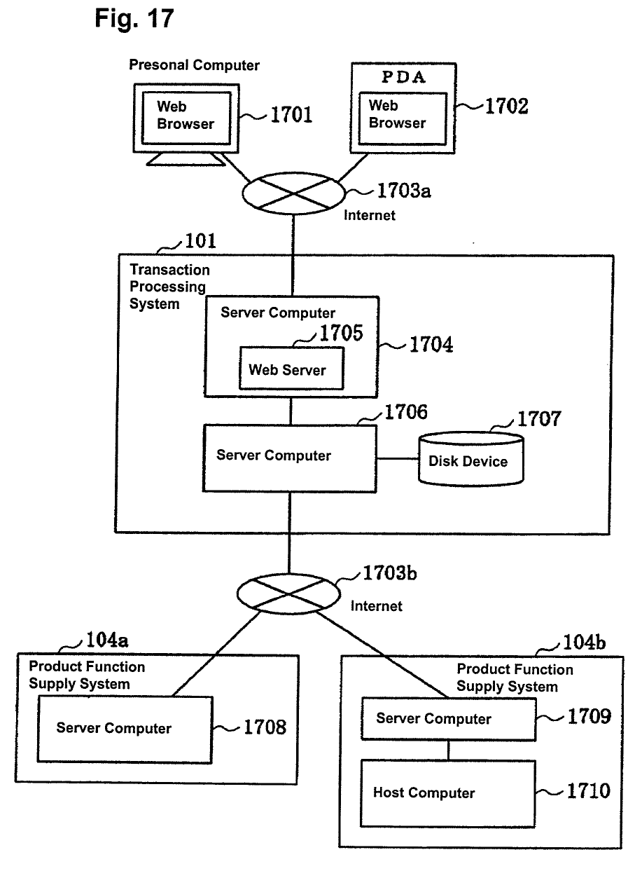

The processing operations in the product brokerage transaction processing system in this example explained above can be achieved by executing a program in the data processing device (computer) shown in FIG. 17. Also, the program may be stored in a computer-readable recording medium such as a DVD-ROM, CD-ROM, FD (Flexible Disk) and the like. The program can also be stored in a hard disk device, etc., and is accessible via a network.

FIG. 17 is a block diagram showing an example of the hardware configuration applicable to the product brokerage transaction processing system in FIG. 1.

Each of the terminals 103a-103b used by the respective end-users 102a-102b in FIG. 1 may be composed of a personal computer 1701 that has a CPU (Central Processing Unit), a main memory, a HDD (Hard Disk Drive), etc., or a mobile terminal PDA (Personal Digital Data Assistants) 1702. The display and input are performed through Java applets on the web-browser. As such, end-users can use the financial transaction processing system with commonly available terminals and software.

Also, the networks 105a and 105b in FIG. 1 can be the Internet 1703a and 1703b. Then messages for the financial transaction processing system can be exchanged through commonly used communication lines.

Furthermore, the transaction processing system 101 at the brokerage institution 1601 in FIG. 1 has server computers 1704 and 1706, and a disk device 1707. The front-end server section 116 in FIG. 1 is activated and operated at a web server 1705 in the server computer 1704.

Also, the product information management section 106, the integrated product definition information management section 108, the contract information management section 110, the end-user information management section 119, the transaction execution control section 112, the message send/receive section 115, and the commission settlement management section 116 in FIG. 1 each operate on the server computer 1705. The disk device 1707 maintains the product information 107, the integrated processing definition information 109, the contract information 111, the end-user attribute information 118, and the transaction log 113, and the commission billing detail information in FIG. 1.

For example, the financial function offering systems 104a and 104b operate on a server computer 1708 and a host computer 1710 connected to a gateway system on a server computer 1709, respectively.

As explained with reference to FIGS. 1-17 above, in the processing brokerage transaction processing system and the product brokerage transaction processing method in accordance with the embodiment of the present invention, the transaction processing system 101 is provided at a brokerage institution to mediate and process transactions across multiple financial institutions, and it registers, in this transaction processing system, the product information 107 containing function attributes of financial products offered by each financial institution and message specifications when performing transaction of the financial products, and commission rules regarding transactions for these financial products sent from the product function offering systems 104a-104c.

In the transaction processing system 101 at the brokerage institution, the system registers a transaction flow of each integrated product which is a combination of products, for example, a work flow definition which is a collection of transaction steps wherein each step is a transaction for each product offered by each of the financial institutions. When the end-user 102a, 102b inputs parameters for the transaction flow of an integrated product, which are selected from items in each product information, the system executes and controls the transaction processing according to the transaction flow definition and these parameters in the transaction processing system 101.

Furthermore, in the transaction processing system 101, the system obtains the transaction log 113 indicating a history of the applicable transaction when performing a transaction for each product, prepare a settlement detail according to the applicable transaction log 113, and performs a settlement with the financial institution.

By using the system based on the product information maintenance function, the transaction flow definition information function for integrated products, the transaction flow parameter information maintenance function, and the transaction flow execution control function, one can support a new transaction for integrated products by adding information such as those relating to registration of product information, registration and change of the transaction flow of integrated products, additional parameters. In this manner, a transaction system of financial products across multiple financial institutions can be readily developed.

Also, this invention is not limited to the embodiments described with reference to FIGS. 1-17, and many modifications can be made within the range that does not depart from the subject matter of the present invention. For example, in the present embodiment, the brokerage system for financial products is described, however, the present invention is also applicable to brokerage transactions of other products.

Furthermore, in the embodiment example, insurance premium deposits, mutual funds, automatic loans, etc., are described as examples for the financial products, however, the present invention is also applicable to transactions of other financial products.

In addition, in present embodiment example, a web-server and web-browser via the Internet 1703a are used for accesses from the PDA 1702. However, other communication systems can be structured, For example, the PDA 1702 may be first connected wireless to a wireless station, then to the Internet 1703a through the wireless station.

Also, in the present embodiment example, DVD-ROMs, CD-ROMs and FDs are listed as a recording medium for storing the programs. However, the programs can be downloaded through a network using a communication device and installed.

In accordance with the present invention, a brokerage institution can perform transactions for integrated products which consist of multiple financial products, by having multiple financial institutions register product information, and the systems at the multiple financial institutions can be cooperated in a flexible fashion. As a result, users can readily use transactions of financial products across multiple financial institutions.

While the description above refers to particular embodiments of the present invention, it will be understood that many modifications may be made without departing from the spirit thereof The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A product brokerage transaction processing system that mediates products offered by at least one product supply system and supplies the products to terminals of end-users connected via a network, the product brokerage transaction processing system comprising:
a device that collects through the network from the at least one product supply system product information containing information indicative of characteristics of the products offered by the at least one product supply system, message specifications to be used for transaction of the products, and commission information to be used for settlement of commissions for brokerage transaction of the products, and registers the product information in a storage device in association with the at least one product supply system;
a device that selects a plurality of products from the products registered in the product information, generates combinations of the plurality of products to form integrated products each having a series of transaction steps, and stores information indicative of the respective integrated products in a storage device;
a device that provides the terminals via the network with information about the integrated products;
a device that collects contract information containing information about an integrated product selected from the integrated products at any of the end-user terminals by an end-user based on the information about the integrated products and contract details for a plurality of products composing the selected integrated product, and registers the contract information in a storage device in association with the end-user;
a device that starts a brokerage transaction for the integrated product based on the contract details of the contract information, specifies product supply systems that supply the products composing the integrated product and message specifications to be used for transactions for the products, send notifications of the contract details for the products according to the specified message specifications to the specified product supply systems, and allows the specified product supply systems to execute the transactions for the products;
a device that stores a transaction log indicating transaction execution details for the products performed by the product supply systems based on the notifications in a storage device in association with the product supply systems; and
a device that performs commission settlements for the brokerage transaction for the products transacted with the product supply systems based on the stored transaction log for the products and commission information of the products.

2. A product brokerage transaction processing system that mediates financial products offered by at least one financial institution and supplies the financial products to terminals of end-users connected via a network, the product brokerage transaction processing system comprising:
a device that collects through the network from the at least one financial institution product information containing information indicative of characteristics of the financial products offered by the at least one financial institution, message specifications to be used for transaction of the financial products, and commission information to be used for settlement of commissions for brokerage transaction of the financial products, and registers the product information in a storage device in association with the at least one financial institution;
a device that selects a plurality of financial products from the financial products registered in the product information, generates combinations of the plurality of financial products to form integrated products each having a series of transaction steps, and stores information sets indicative of the respective integrated products in a storage device;
a device that provides the terminals via the network with information about the integrated products;
a device that collects contract information containing information about an integrated product selected from the integrated products at any of the end-user terminals by an end-user based on the information about the integrated products and contract details for a plurality of financial products composing the selected integrated product, and registers the contract information in a storage device in association with the end-user;
a device that starts a brokerage transaction for the integrated product based on the contract details of the contract information, specifies financial institutions that supply the financial products composing the integrated product and message specifications to be used for transactions for the products, send notifications of the contract details for the financial products according to the specified message specifications to the specified financial institutions, and allows the specified financial institutions to execute the transactions for the financial products;
a device that stores a transaction log indicating transaction execution details for the financial products performed by the financial institutions based on the notifications in a storage device in association with the financial institutions; and
a device that performs commission settlements for the brokerage transaction for the financial products transacted with the financial institutions based on the stored transaction log for the financial products and commission information of the financial products.

3. A product brokerage transaction processing system according to claim 1, wherein the integrated product is composed of a work flow associating the plurality of products that compose the integrated product.

4. A product brokerage transaction processing system according to claim 2, wherein the integrated product is composed of a work flow associating the plurality of financial products that compose the integrated product.

5. A product brokerage transaction processing method for at least one product supply system that offers products and a product transaction processing system that is connected via a network to the at least one product supply system and mediates products offered by the at least one product supply system and supplies products to terminals of end-users connected via a network, the product brokerage transaction processing system method comprising:
a process that at the product transaction processing system, collects through the network from the at least one product supply system product information containing information indicative of characteristics of the products offered by the at least one product supply system, message specifications to be used for transaction of the products, and commission information to be used for settlement of commissions for brokerage transaction of the products, and register the product information in a storage device in association with the at least one product supply system;
a process that, at the product transaction processing system, selects a plurality of products from the products registered in the product information, generate combinations of the plurality of products to form integrated products each having a series of transaction steps, and store information sets indicative of the respective integrated products in a storage device;
a process that provides form the product transaction processing system to the terminals via the network with information about the integrated products;
a process that sends from any of the terminals of end-users to the transaction processing system via the network contract information containing information about an integrated product selected by an end-user based on the information about the integrated products and contract details for products composing the selected integrated product;
a process that registers in a storage device at the transaction processing system the contract information sent from the terminal of the end-user in association with the end-user;
a process that starts at the transaction processing system a brokerage transaction for the integrated product based on the contract details of the contract information, specifies product supply systems that supply the products composing the integrated product and message specifications to be used for transactions for the products, send notifications of the contract details for the products according to the specified message specifications to the specified product supply systems that supply the products;
a process that executes transactions for products corresponding to the contract details at the specified product supply systems that are notified of the contract details from the transaction processing system and supply the products;
a process that stores at the transaction processing system a transaction log indicating transaction execution details for the products performed by the product supply systems in a storage device in association with the product supply systems; and
a process that performs at the transaction processing system commission settlements for the brokerage transaction for the products transacted with the product supply systems based on the stored transaction log for the products and commission information of the products.

6. A product brokerage transaction processing method for at least one financial institution system that offers financial products and a product transaction processing system that is connected via a network to the at least one financial institution system and mediates financial products offered by the at least one financial institution system and supplies financial products to terminals of end-users connected via a network, the product brokerage transaction processing system method comprising:
a process that, at the product transaction processing system, collects through the network from the at least one financial institution system product information containing information indicative of characteristics of the financial products offered by the at least one financial institution system, message specifications to be used for transaction of the financial products, and commission information to be used for settlement of commissions for brokerage transaction of the financial products, and registers the product information in a storage device in association with the at least one financial institution system;
a process that, at the product transaction processing system, selects a plurality of financial products from the financial products registered in the product information, generates combinations of the plurality of financial products to form integrated products each having a series of transaction steps, and stores information sets indicative of the respective integrated products in a storage device;
a process that provides form the product transaction processing system to the terminals via the network with information about the integrated products;
a process that sends from any of the terminals of end-users to the transaction processing system via the network contract information containing information about an integrated product selected by an end-user based on the information about the integrated products and contract details for financial products composing the selected integrated product;
a process that registers in a storage device at the transaction processing system the contract information sent from the terminal of the end-user in association with the end-user;
a process that starts at the transaction processing system a brokerage transaction for the integrated product based on the contract details of the contract information, specifies financial institution systems that supply the financial products composing the integrated product and message specifications to be used for transactions for the financial products, send notifications of the contract details for the financial products according to the specified message specifications to the specified financial institution systems that supply the financial products;
a process that executes transactions for financial products corresponding to the contract details at the specified financial institution systems that are notified of the contract details from the transaction processing system and supply the financial products;
a process that stores at the transaction processing system a transaction log indicating transaction execution details for the financial products performed by the financial institution systems in a storage device in association with the financial institution systems; and
a process that performs at the transaction processing system commission settlements for the brokerage transaction for the financial products transacted with the financial institution systems based on the stored transaction log for the financial products and commission information of the financial products.

7. A product brokerage transaction processing method according to claim 5, further comprising a process that generates the integrated product with a work flow associating a plurality of products that compose the integrated product.

8. A product brokerage transaction processing method according to claim 6, further comprising a process that generates the integrated product with a work flow associating a plurality of financial products that compose the integrated product.

9. A program that executes the processes in the product brokerage transaction processing method according to claim 5.

10. A program that executes the processes in the product brokerage transaction processing method according to claim 6.

11. A brokerage transaction processing system for a brokerage system that mediates and processes transactions between users and multiple product supply systems, the brokerage transaction processing system comprising:
a device that registers product information containing information indicating functional characteristics of products offered by each of the product supply systems, message specifications for performing transactions of the products, and rules regarding commissions for the transactions of the products;
a device that registers flows of transactions of integrated products, each of the integrated products being composed of a plurality of products;
a brokerage transaction device that, in response to an input by an end-user of parameters that define a transaction flow for an integrated product composing a plurality of products selected from the registered product information, performs a brokerage transaction process according to the transaction flow and the selected parameters;
a device that registers a transaction log indicating a transaction history for each of the products composing the integrated product when executing a transaction process for each of the products; and
a device that executes a settlement based on the transaction log between each of the product supply systems and the brokerage system.

12. A brokerage transaction processing system according to claim 11, further comprising a device that collects contract information containing information about the integrated product integrating a plurality of products selected from the product information by the end-user and contract details for the plurality of products composing the integrated product, and registers the contract information in a storage device in association with each of the end-users.

13. A brokerage transaction processing system according to claim 12, wherein the brokerage transaction device starts a brokerage transaction for the integrated product based on contract details of the contract information, specifies product supply systems that supply the products composing the integrated product and message specifications identifying transaction specifications for the products, send notifications of the contract details for the products according to the specified message specifications to the specified product supply systems, and allows the specified product supply systems to execute the transaction processes for the respective products.

14. A brokerage transaction processing system according to claim 11, wherein a plurality of transaction logs each containing details of a transaction execution for each of the products performed by each of the product supply systems are stored in the storage device in association with each of the respective product supply systems.

15. A product brokerage transaction processing system according to claim 11, wherein the integrated product is composed of a work flow associating the plurality of products that compose the integrated product.

16. A brokerage transaction processing method for operating a brokerage system that mediates and processes transactions between users and multiple product supply systems, the brokerage transaction processing method comprising the steps of:
registering product information containing information indicating functional characteristics of products offered by each of the product supply systems, message specifications for performing transactions of the products, and rules regarding commissions for the transactions of the products;
registering flows of transactions of integrated products, each of the integrated products being composed of a plurality of products;
in response to an input by an end-user of parameters that define a transaction flow for an integrated product composing a plurality of products selected from the registered product information, performing a brokerage transaction process according to the transaction flow and the selected parameters;
registering a transaction log indicating a transaction history for each of the products composing the integrated product when executing a transaction process for each of the products; and
executing a settlement based on the transaction log between each of the product supply systems and the brokerage system.

17. A brokerage transaction processing method according to claim 16, further comprising the steps of collecting contract information containing information about the integrated product integrating a plurality of products selected from the product information by the end-user and contract details for the plurality of products composing the integrated product, and registering the contract information in a storage device in association with each of the end-users.

18. A brokerage transaction processing method according to claim 17, wherein the step of performing the brokerage transaction starts a brokerage transaction for the integrated product based on contract details of the contract information, specifies product supply systems that supply the products composing the integrated product and message specifications for transaction specifications for the products, sends notifications of the contract details for the products according to the specified message specifications to the specified product supply systems, and allows the specified product supply systems to execute the transaction processes for the respective products.

19. A brokerage transaction processing method according to claim 16, wherein a plurality of transaction logs each containing details of a transaction execution for each of the products performed by each of the product supply systems are stored in the storage device in association with each of the respective product supply systems.

20. A product brokerage transaction processing method according to claim 16, wherein the integrated product is composed of a work flow associating the plurality of products that compose the integrated product.
